(19) United States
(12) Patent Application Publication
(10) Pub. No.: US 2020/0050479 A1
(43) Pub. Date: Feb. 13, 2020

(54) BLOCKCHAIN NETWORK AND TASK SCHEDULING METHOD THEREFOR

(71) Applicant: SPACEBOOK TECHNOLOGY CO. LIMITED, Road Town (VG)

(72) Inventors: DAXIN ZHU, SHENZHEN (CN); YU WANG, SHENZHEN (CN)

(21) Appl. No.: 16/244,054

(22) Filed: Jan. 9, 2019

(30) Foreign Application Priority Data
Aug. 9, 2018 (CN) 201810902952.0

(51) Int. Cl. G06F 9/48; H04L 9/06; G06F 11/14

(52) U.S. Cl. CPC G06F 9/4881; H04L 9/0637; G06F 2201/805; H04L 2209/38; G06F 11/1464

(57) ABSTRACT

A blockchain network and a task scheduling method therefor are provided. The blockchain network includes: a management node and multiple storage node communicable connected with the management node. The management node selects a storage node in response to a task requirement of a client node, and the selected storage node sends data to the client node according to the task requirement. As such, a reasonable scheduling scheme is provided by way of the management node, it can schedule the storage nodes for providing services according to the task of the client node, and therefore a stable and efficient task processing service can be provided within a normal capacity of the storage node.

### FIELD OF THE DISCLOSURE

The disclosure relates to the field of blockchain technologies, and more particularly to a blockchain network and a task scheduling method therefor.

### BACKGROUND

At present, blockchain networks in the industry mainly include two types. One type is a p2p network, and the so-called p2p is a peer-to-peer network technology. The status of each node in the p2p network is equal, and the node is both a server and a client. Each node enjoys services provided by other nodes and also serves other nodes. The other type is similar to a cloud download CDN (content delivery network).

The p2p network has the advantage of low cost, and ordinary users can provide free traffic when using computers. However, in the p2p network, the provision of data services is unstable. For example, in multiple p nodes, there are at least some personal computers whose online states and networks are unstable and unreliable. The advantage of the cloud download CDN solution is that the download speed is high. However, cloud vendors need to provide many specialized computer room nodes as server nodes, and thus the cost is high and bandwidth requirements are also high. When a download peak exceeds the bandwidth provided by a service provider, the service cannot be rapidly expanded.

In addition, the existing p2p network does not have a unified traffic management center in terms of traffic statistics, so it is impossible to make global traffic resource allocation calls. Moreover, there are no available incentives when nodes provide services, so that ordinary users are less motivated to use their own machines for sharing.

### SUMMARY

In view of the above issues in the related art, the disclosure provides a blockchain network and a task scheduling method therefor, which can provide an efficient and stable system.

Technical solutions of the disclosure are embodied as follows.

According to an aspect of the disclosure, a blockchain network includes: a management node and a plurality of storage nodes communicably connected with the management node. The management node is configured (i.e., structured and arranged) for selecting a storage node front the plurality of storage nodes in response to a task requirement of a client node, and the selected storage node is configured for sending data to the client node according to the task requirement.

According to an embodiment of the disclosure, each of the plurality of storage nodes is communicably connected with a plurality of network host nodes, and a backup network host node of the plurality of network host nodes is configured for sending backup data to the client node according to the task requirement.

According to an embodiment of the disclosure, the management node is configured for selecting the storage node according to at least one of following scheduling rules that: a total storage space of the storage node, an available storage space of the storage node, a online duration of the storage node an amount of idle network node in multiple network host nodes connected with the storage node, and a total available storage space of idle network node in multiple network host nodes connected with the storage node.

According to an embodiment of the disclosure, the blockchain network further includes: a bookkeeping node, communicably connected with corresponding ones of the plurality of storage nodes, and configured for obtaining a first data statistics information sent from the client node, a second data statistics information sent from the selected storage node and a third data statistics information sent from the backup network host node.

According to an embodiment of the disclosure, the management node is further configured for rewarding the selected storage node and the backup network host node according to the second data statistics information and the third data statistics information.

According to an embodiment of the disclosure, the management node includes: a returning module, configured to return location information of the selected storage node to the client node, and correspondingly the client node sends a task request to the selected storage node according to the location information.

According to an embodiment of the disclosure, the returning module is further configured to return an access key to the client node, and the management node is further configured for sending a verification key to the selected storage node; and correspondingly the client node sends the task request to the selected storage node by use of the access key, and the selected storage node verifies a validity of the task request by use at the verification key.

According to another aspect of disclosure, a task scheduling method for a blockchain network, includes: selecting a storage node in response to a task requirement of a client node; and sending data to the client node from the selected storage node according to the task requirement.

According to an embodiment of the disclosure, after sending data to the client node from the selected storage node the task scheduling method further includes: sending backup data to the client node from a backup network host node according to the task requirement.

According to an embodiment of the disclosure, the storage node is selected based on at least one of following scheduling rules that: a total storage space of the storage node, an available storage space of the storage node, a online duration of the storage node, an amount of idle network node in multiple network host nodes connected with the storage node, and a total available storage space of idle network node in multiple network host nodes connected with the storage node.

According to an embodiment of the disclosure, after sending data to the client node from the selected storage node, the task scheduling method further includes: obtaining a first data statistics information sent from the client node, a second data statistics information sent from the selected storage node and a third data statistics information sent from the backup network host node.

According to an embodiment of the disclosure, after obtaining the second data statistics information and the third data statistics information, the task scheduling method further includes: rewarding the selected storage node and the backup network host node according to the second data statistics information and the third data statistics information.

According to an embodiment of the disclosure, after selecting the storage node, the task scheduling method further includes: returning location information of the selected storage tunic to the client node; and sending a task request to the selected storage node from the client node according to the location information.

According to an embodiment of the disclosure, after selecting the storage node, the task scheduling method further includes, returning an access key to the client node, and sending a verification key to the selected storage node. Correspondingly, the client node sends the task request to the selected storage node by use of the access key, and the selected storage node verifies a validity of the task request by use of the verification key.

Sum up, the disclosure provides a reasonable scheduling scheme by use of the management node, and can adjust the storage node for providing services according to the task of the client node. Therefore, within a normal capacity of the storage node, a stable and efficient task processing service is provided. Moreover, by centrally collecting traffic conditions of the network, the nodes scheduling scheme can be further optimized according to collected data statistics information to provide a more stable and efficient task processing service. In addition, by collecting statistics information of the nodes, it can more objectively evaluate the resource capabilities of the respective nodes and make corresponding rewards, and enthusiasm of each node to provide services is improved consequently.

### BRIEF DESCRIPTION OF THE DRAWINGS

In order to more clearly illustrate embodiments of the disclosure or the technical solutions in related art, drawings used in the embodiments will be briefly introduced below. Apparently, the drawings in the description below are merely some embodiments of the disclosure, a person skilled in the art can obtain other drawings according to these drawings without creative efforts.

FIG. 1 is a structural schematic view of a blockchain network according to an embodiment of the disclosure.

FIG. 2 is schematic view of data flows of nodes in a blockchain network according to an embodiment of the disclosure.

FIG. 3 is a flowchart of a task scheduling method for a blockchain network according to an embodiment of the disclosure.

FIG. 4 is a flowchart of a task scheduling method for a blockchain network according to another embodiment of the disclosure.

FIG. 5 is a flowchart of a task scheduling method tor a blockchain network according to still another embodiment of the disclosure.

FIG. 6 is a flowchart of a task scheduling method for a blockchain network according to even still another embodiment of the disclosure.

### DETAILED DESCRIPTION OF EMBODIMENTS

Technical solutions of embodiment of the disclosure will be clearly and fully described in the following with reference to the accompanying drawings in the embodiments of the disclosure. Apparently, the described embodiments are some of the embodiments of the disclosure, but not all of the embodiments. All other embodiments obtained by skilled person in the art based on the described embodiments of the disclosure are within the scope of protection of the instant application.

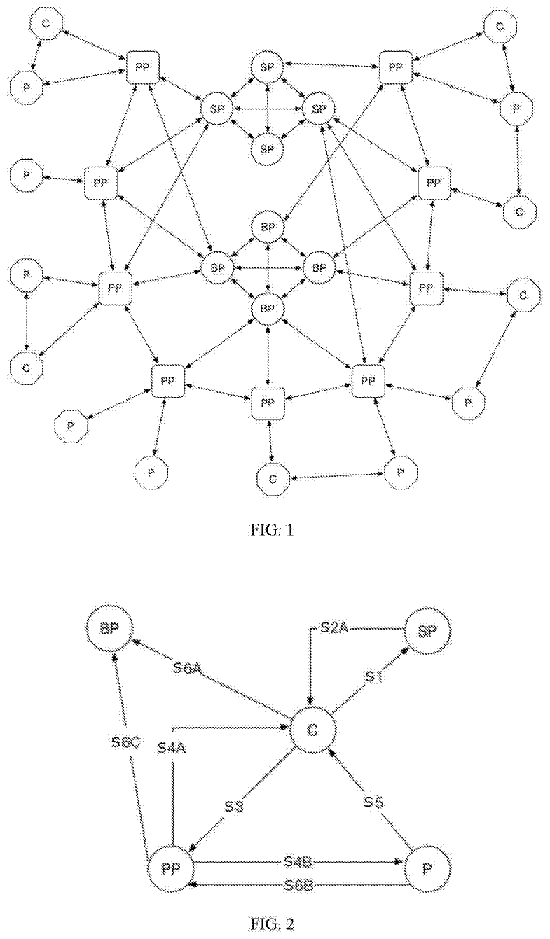

Referring to FIG. 1, an embodiment of the disclosure provides a blockchain network. The blockchain network includes management nodes SP and multiple storage nodes PP communicably connected to the management nodes SP. The management node SP may select a storage node PP in response to a task requirement of a client node C, and the storage node PP selected by the management node SP sends corresponding data to the client node C according to the task requirement. It should be understood that, the storage node PP selected by the management node SP has data required for the task of the client node C. Task requirements of the client node C may include file download tasks, file storage tasks, or any other type of task.

According to the above technical solution of the disclosure, a reasonable scheduling scheme is provided by use of the management node SP, and the storage nodes PP for providing services can be scheduled according to the tasks of the client node C. Thus, a stable and efficient task processing service is provided within normal capacities of the storage nodes PP.

With continued reference to FIG. 1, each storage node PP is communicably connected to multiple network host nodes P. A backup network host node P in the multiple network host nodes sends backup data to the client node C according to a task requirement. The backup network host node P refers to the network host node P that backs up data content required for the task requirement. In particular, under a certain condition, for example, when a bandwidth pressure of the selected storage node PP is greater than a predetermined value, the storage node PP selected by the management node SP sends a command to the backup network host node P to ask the backup network host node P to assist providing download. In other words, when the bandwidth pressure of the storage node PP is large, the download tasks can be shared by the network host node P, thereby maximizing the utilization of network performance and bandwidth, and avoiding congestion of service.

Broadly speaking, in the blockchain network of the disclosure, functions of the management node SP may include, task scheduling, address mapping of data reading, full synchronization of state information of the storage nodes PP in the management node SP, and storage and backup of data storage index relationship information in a cluster composed of multiple nodes SP. Functions of the storage node PP may include: performing data storage tasks, providing a stable and fast data access acceleration service, assigning data storage tasks to the network host nodes P, and managing multiple network host nodes P connected thereto. Functions of the network host node P may include: providing data access and uplink bandwidth traffic sharing.

The management node SP selects a storage node PP according to at least one of the following scheduling rules: a total storage space of the storage node PP, an available storage space of the storage node PP, a online duration of the storage node PP, an amount of idle network node in multiple network host nodes P connected with the storage node PP, and a total available storage space of idle network node in multiple network host nodes P connected with the storage node PP. It should be understood that, the scheduling rule may be configured according to actual application conditions, and the disclosure does not limit it. By way of the configuration of the scheduling rule, the scheduling scheme of the management node SP can be reasonably adjusted.

The blockchain network according to an embodiment of the disclosure further includes a bookkeeping node BP, communicably connected to multiple corresponding storage nodes PP. The bookkeeping node BP is configured (i.e., structured and arranged) for obtaining data statistics information sent front the client node C, data statistics information sent from the selected storage node PP, and data statistics information sent from the backup network host node P. Based on the data statistics information sent from the client node C, the data statistics information sent from the selected storage node PP and the data statistics information sent from the backup network host node P, the management node SP can reward the selected storage node PP and the backup network host node accordingly. In such way, by centrally collecting the traffic environment of the network, the node scheduling scheme can be further optimized based on collected data statistics information to provide a more stable and efficient task processing service; and moreover, by collecting the statistics information of the nodes, it can more objectively evaluate the resource capability of each node and make a corresponding reward, as a result, enthusiasm of providing services of the nodes is improved.

In addition, in response to a task requirement of the client node C, the management node SP may further be used to return location information of the selected storage node PP to the client node C. Furthermore, the client node C sends a task request to the selected storage node PP according to the loan ion information correspondingly. The management node SP is further used to return an access key to the client node C and is also used to send a verification key to the selected storage node PP. The client node C sends the task request to the selected storage node PP by use of the access key, and the storage node PP verifies the validity of the task request by use of the verification key.

Referring to FIG. 1, data flows of the nodes in a blockchain network according to an embodiment of the disclosure will be described below. In this embodiment, a task requirement of the client node being a file download task is taken as an example for illustration.

In a data flow of S1, the client node C sends a file download request to the management node SP.

In a data flow of S2A, the management node SP returns location information and an access key of a storage node PP where the requested file is located (i.e., the storage node PP selected by the management node SP).

In a data flow of S2B (not shown), the management node SP sends a verification key to the storage node PP wherein the file is located.

In a data flow of S3, the client node C uses the access key to request the storage node PP where the file is located for file download. In particular, the client node C sends a file down request to the storage node PP where the tile is located by use of the access key, and the storage node PP where the file is located uses the verification key to verify the validity of the file download request sent from the client node C.

In a data flow of S4A, in the situation of the file download request sent from the client node C passes the validity verification, the selected storage node PP sends file data to the client node C.

In a data flow of S4B, the storage node PP sends a command to a node P that has backed up file data content to ask the node P to assist providing download.

In a data flow of S5, the backup network host node P sends file data to the client node C.

In a data flow of S6A, the client node C reports sent data statistics information to the bookkeeping node BP.

In a data flow of S6B, the backup network host node P sends statistics information of downloaded data provided for the present task to the storage node PP, and requests the storage node PP to forward the statistics information to the bookkeeping node BP.

In a data flow of 6C, the storage node PP sends its own statistical data information together with statistical data information submitted by the backup network host node P to the bookkeeping node BP.

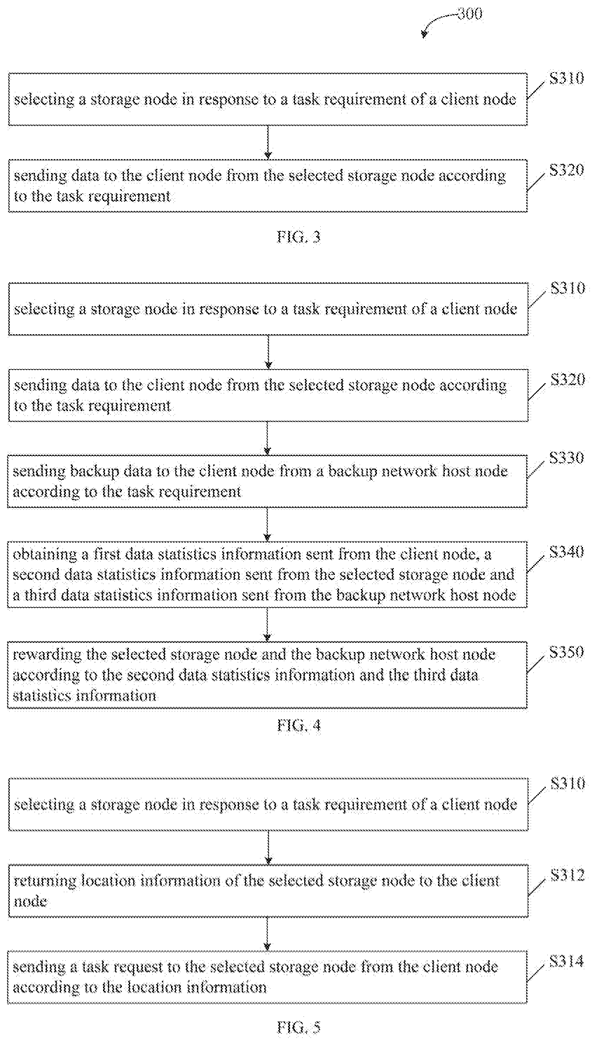

According to an embodiment of the disclosure, as illustrated in FIG. 3, a task scheduling method 300 for a blockchain network is provided and includes the following steps:

Step S310: selecting a storage node in response to a task requirement of a client node;

Step S320: sending data to the client node from the selected storage node according to the task requirement.

Moreover, as illustrated in FIG. 4, the task scheduling method 300 may further include a step S330: sending backup data to the client node from a backup network host node according to the task requirement.

In the step S310, the storage node is selected based on at least one of the following scheduling rules: a total storage space of the storage node, an available storage space of the storage node, a online duration of the storage node, an amount of idle network node in multiple network host nodes connected with the storage node, and a total available storage space of idle network node in multiple network host nodes connected with the storage node.

In addition, as illustrated in FIG. 4, the task scheduling method 300 may further include a step S340: obtaining a First data statistics information sent from the client node, a second data statistics information sent from the selected storage node and a third data statistics information sent from the backup network host node.

As illustrated in FIG. 4, after the step S340, the task scheduling method 300 may further include a step S350: rewarding the selected storage node and the backup network host node according to the second data statistics information and the third data statistics information.

In another embodiment, as illustrated in FIG. 5, after the step S310, the task scheduling method may further include a step S312 and a step S314. Step S312: returning location information of the selected storage node to the client node; and Step S314: sending a task request to the selected storage node from the client node according to the location information.

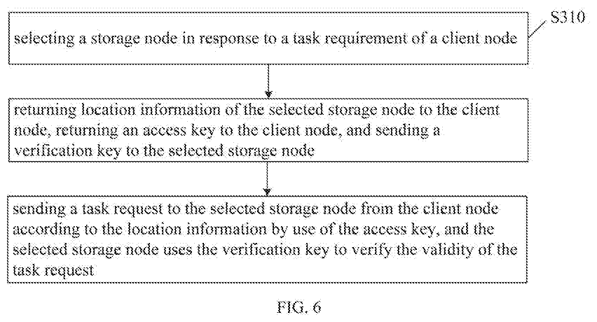

In still another embodiment, as illustrated in FIG. 6, after the step S310, the task scheduling method may further include retaining an access key to the client node, and sending a verification key to the selected storage node. Correspondingly, the client node sends a task request to the selected storage node by use of the access key, and the selected storage.

The foregoing are only illustrated embodiments of the disclosure and not intended to limit the disclosure. Any modifications, equivalent substitutions, improvements, etc., made within the spirit and scope of the disclosure, should be included in the protection scope of the application.

What is claimed is:

1. A blockchain network, comprising, a management node and u plurality of storage nodes communicably connected with the management node;
wherein the management node is configured for selecting a storage node from the plurality of storage nodes in response to a task requirement of a client node, and the selected storage node is configured for sending data to the client node according to the task requirement.

2. The blockchain network as claimed in claim 1, wherein each of the plurality of storage nodes is communicably connected with a plurality of network host nodes, and a backup network host node of the plurality of network host nodes is configured for sending backup data to the client node according to the task requirement.

3. The blockchain network as claimed in claim 2, wherein the management node is configured for selecting the storage node according to at least one of following scheduling rules that:
a total storage space of the storage node, an available storage space of the storage node, a online duration of the storage node, an amount of idle network node in multiple network host nodes connected with the storage node, and a total available storage space of idle network node in multiple network host nodes connected with the storage node.

4. The blockchain network as claimed in claim 2, further comprising;
a bookkeeping node, communicably connected with corresponding ones of the plurality of storage nodes, and configured for obtaining a first data statistics information sent from the client node, a second data statistics information sent from the selected storage node and a third data statistics information sent from the backup network host node.

5. The blockchain network its claimed in claim 4, wherein the management node is further configured for rewarding the selected storage node and the backup network host node according to the second data statistics information and the third data statistics information.

6. The blockchain network as claimed in claim 1, wherein the management node is further configured for returning location information of the selected storage node to the client node, and correspondingly the client node sends a task request to the selected storage node according to the location information.

7. The blockchain network as claimed in claim 6, wherein the management node is further configured for returning an access key to the client node and sending a verification key to the selected storage node; and correspondingly the client node sends the task request to the selected storage node by use of the access key, and the selected storage node verifies a validity of the task request by use of the verification key.

8. A task scheduling method for a blockchain network, comprising:
selecting a storage node in response to a task requirement of a client node; and
sending data to the client node from the selected storage node according to the task requirement.

9. The task scheduling method for a blockchain network as claimed in claim after sending data to the client node from the selected storage node, further comprising:
sending backup data to the client node from a backup network host node according to the task requirement.

10. The task scheduling method for a blockchain network as claimed in claim 9, wherein the storage node is selected based on at least one of following scheduling rules that:
a total storage space of the storage node, an available storage space of the storage node, a online duration of the storage node, an amount of idle network node in multiple network host nodes connected with the storage node, and a total available storage space of idle network node in multiple network host nodes connected with the storage node.

11. The task scheduling method for a blockchain network as claimed in claim 9, after sending data to the client node from the selected storage node, further comprising:
obtaining a first data statistics information sent from the client node, a second data statistics information sent from the selected storage node and a third data statistics information sent from the backup network host node.

12. The task scheduling method for a blockchain network as claimed in claim 11, after obtaining the second data statistics information and the third data statistics information, further comprising:
rewarding the selected storage node and the backup network host node according to the second data statistics information and the thud data statistics information.

13. The task scheduling method for a blockchain network as claimed in claim 8, after selecting the storage node, further comprising:
returning location information of the selected storage node to the client node;
sending a task request to the selected storage node from the client node according to the location information.

14. The task scheduling method for a blockchain network as claimed in claim 13, after selecting the storage node, further comprising:
returning an access key to the client node, and sending a verification key to the selected storage node;
wherein the client node sends the task request to the selected storage node by use of the access key, and the selected storage node verifies a validity of the task request by use of the verification key correspondingly.
